(19) United States
(12) Patent Application Publication
(10) Pub. No.: US 2001/0046027 A1
(43) Pub. Date: Nov. 29, 2001

(54) LIQUID CRYSTAL DISPLAY HAVING STRIPE-SHAPED COMMON ELECTRODES FORMED ABOVE PLATE-SHAPED PIXEL ELECTRODES

(76) Inventors: YA-HSIANG TAI, TAIPEI (TW); LISEN CHUANG, PENGHU (TW); CHIH-HONG CHEN, HSINCHU (TW)

Correspondence Address: JASON Z LIN, 19597 VIA MONTE DRIVE, SARATOGA, CA, 95070

(21) Appl. No.: 09/444,141

(22) Filed: Nov. 20, 1999

(30) Foreign Application Priority Data
Sep. 3, 1999 (TW) 88115182

(51) Int. Cl. G02F 1/1333

(52) U.S. Cl. 349/159

(57) ABSTRACT

An electrode structure has independent pixel electrodes and connected common electrodes for a wide viewing angle liquid crystal display. The pixel electrode being a plate-shaped structure is fabricated on a lower layer above a substrate. The common electrode being a striped-shape structure is formed in an upper layer above the substrate. The common electrode may be a herringbone-shaped structure. The pixel electrodes and the common electrodes may overlay the data signal lines of the liquid crystal display. The arrangement of the electrode structure increases the effective light transmission. The electrode structure has the advantages that the tolerance for an electrostatic breakdown or residual electric charges is increased, and reproduction process is simplified.

### FIELD OF THE INVENTION

The present invention relates generally to an electrode structure and fabrication method of a liquid crystal display, and more particularly to an electrode structure of a wide viewing angle liquid crystal display and its fabrication method.

### BACKGROUND OF THE INVENTION

A large number of liquid crystal display panels (LCD) have recently been employed as display devices in electronic products. The technologies of the wide viewing angle liquid crystal display are discussed very often in recent years. Among them, a conventional technology of the wide viewing angle liquid crystal display is implemented by an in-plane switch (IPS) mode. A disadvantage of this technology is that it is difficult to raise the effective transmission of light because its comb-shaped pixel electrodes and common electrodes are fabricated by metal.

Recently a new technology, called fringe field switch (FFS) mode, has been developed. Its pixel electrodes and common electrodes are fabricated by transparent indium-tin-oxide (ITO) which can significantly increase the brightness of the liquid crystal display device. In the design of the electrode structure in a fringe field switch mode LCD, the pixel electrode has a comb-shaped structure while the common electrode has a plate-shaped structure. Moreover, the comb-shaped pixel electrodes must be placed above the plate-shaped common electrodes. The electrode structure design in a fringe field switch mode LCD takes two steps of indium-tin-oxide fabrication processes.

FIG. 1 is a top view showing the electrode structure 100 of a single pixel of the conventional wide viewing angle liquid crystal display. As shown in FIG. 1, the pixel electrode 101 in the upper layer of the electrode structure has a comb shape while the common electrode 102 in the lower layer has a plate shape. Within a single pixel, there is a switching device such as a thin film transistor 105 around the crossing point of the scan signal line region 103 and the data signal line region 104. The thin film transistor 105 is an active control switch for charging and discharging a single pixel electrode. In addition to the thin film transistor, the active control element may also be a metal-oxide semiconductor transistor, a diode, a metal-insulator-metal transistor or a variable resistor.

In this electrode structure, the tolerance of misalignment between the upper and the lower electrode layers is fairly large because only the upper pixel electrodes has a comb-shaped structure. The crossing points of the electrodes in the upper and lower layers form naturally the capacitor storage area. Therefore, no extra area that may block some light transmission is required for building the capacitor storage for the LCD. In other words, the effective transmission of light is increased.

FIG. 2 shows a cross section of FIG. 1 where the pixel electrode layer and the common electrode layer are designed on the same substrate. As shown in FIG. 2, this lower plate-shaped common electrode layer 201 of the electrode structure is placed above the glass substrate 202. Between the common electrode layer 201 and the comb-shaped pixel electrodes 203, 204, and 205 is a non-conductive passivation layer 206. The liquid crystal layer 207 is located between the upper and lower glass substrates 201 and 208.

Although the pixel electrodes and the common electrodes in the electrode structure mentioned above may be fabricated by indium-tin-oxide to obtain higher brightness for the liquid crystal display devices, there exist the following disadvantages in this electrode structure:

(a) The transmission of light is not good near the comer of the upper comb-shaped pixel electrodes.

(b) It produces residual electric charges due to the strong electric field at the comer.

(c) It must keep a constant distance between data signal line region and electrodes including common electrodes and pixel electrodes, therefore, reducing the effective transmission of light.

(d) The reproduction is more difficult when forming indium-tin-oxide in the front stage of the later fabrication process.

In order to increase the light transmission of a wide viewing angle liquid crystal display and simplify the fabrication process of the electrode structure, it is desirable that the extra region occupied by the storage capacitor be reduced or eliminated at the design stage of the electrode structure. It is also desirable that the reproduction of forming indium-tin-oxide be handled effectively at the back stage of the later fabrication process.

### SUMMARY OF THE INVENTION

The present invention has been made to overcome the above mentioned drawbacks of a conventional electrode structure of a wide viewing angle liquid crystal display. The primary object of the invention is to provide an electrode structure having independent pixel electrodes and connected common electrodes. The pixel electrodes are fabricated at a lower layer on a substrate while the common electrodes are fabricated at an upper layer above the substrate.

According to the invention, the electrode structure of a wide viewing angle liquid crystal display includes a substrate on which multiple scan signal lines, multiple data signal lines, multiple switching elements, and multiple independent pixel electrodes are fabricated. A passivation layer covers the above structures and a common electrode layer is fabricated thereon. The substrate is a glass substrate. The scan signal lines are substantially perpendicular to the data signal lines in order to form a pixel matrix. The common electrode layer is located on the top level above the glass substrate and the electric conduct is established with the common potential of the driving circuit of the LCD. The passivation layer, which separates the common electrode layer and these multiple independent pixel electrodes, is made of transparent non-conductive insulator and is located between these multiple independent pixel electrodes and the common electrode layer.

For every single pixel, there is at least a switching device near the crossing point of the scan signal line and the data signal line. The gate terminal of this switching device connects to the scan signal line, the drain terminal connects to the data signal line and the source terminal connects to the pixel electrode.

According to the layer arrangement of the electrode structure in this invention, the crossing points of the electrodes in the upper and lower layers form naturally the capacitor storage area. Therefore, no extra area that may block some light transmission is required for building the capacitor storage for the LCD. The effective light transmission of the LCD of the invention is increased.

Another object of the invention is to provide a fabrication method of the electrode structure of a wide viewing angle liquid crystal display. The invention uses the conventional technique to fabricate a substrate and form a layer of plate-shaped pixel electrodes on the substrate. After covering the substrate and the pixel electrodes with a passivation layer, the invention uses stripe-shaped indium-tin-oxide to form a connected common electrode structure. The advantages are that the tolerance to electrostatic breakdown or residual electric charges is larger and the reproduction is easier.

In the present invention, the fabrication method of the electrode structure comprises the following three steps: (a) the formation of a substrate and multiple scan signal lines, multiple data signal lines, multiple switching elements, and multiple independent pixel electrodes on the surface of the substrate; (b) the coverage of a passivation layer; and (c) the formation of a common electrode layer above the passiviation layer. Contact holes are formed outside the region of the pixel matrix for connecting electrodes to signal lines to avoid blocking the transmission of light.

In the preferred embodiments of the present invention, the upper common electrode has a stripe-shaped structure while the lower pixel electrode has a plate-shaped structure. In the first preferred embodiment, the pixel electrodes and the common electrodes do not overlay the data signal lines. In the second preferred embodiment, the pixel electrodes and common electrodes may overlap the data signal lines. The second embodiment provides more effective transmission of light than the first preferred embodiment. In the third preferred embodiment, the upper common electrode has a herringbone-shaped structure. Finally, in order to reduce the resistance, the fourth embodiment of the present invention provides horizontal connections at appropriate locations in the upper common electrode layer.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a top view showing the electrode structure of a single pixel of a conventional wide viewing angle liquid crystal display.

FIG. 2 shows a cross section of FIG. 1.

FIG. 3 is a top view showing the electrode structure of a single pixel of a wide viewing angle liquid crystal display according to the first embodiment of the present invention.

FIGS. 4(a) to 4(f) show the process steps for fabricating the electrode structure in the first embodiment of the present invention.

FIG. 5 is a top view showing the electrode structure of a single pixel of a wide viewing angle liquid crystal display according to the second embodiment of the present invention.

FIGS. 6(a) to 6(g) show the process steps for fabricating the electrode structure in the second embodiment of the present invention.

FIG. 7 is a top view showing the electrode structure of a single pixel of the wide viewing angle liquid crystal display according to the third embodiment of the present invention.

FIG. 8 is a top view showing the electrode structure of a single pixel of the wide viewing angle liquid crystal display according to the fourth embodiment of the present invention.

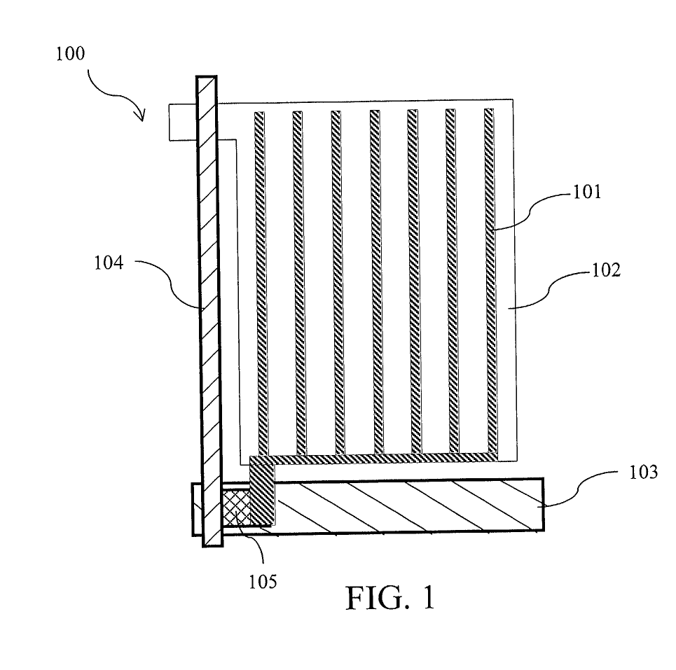

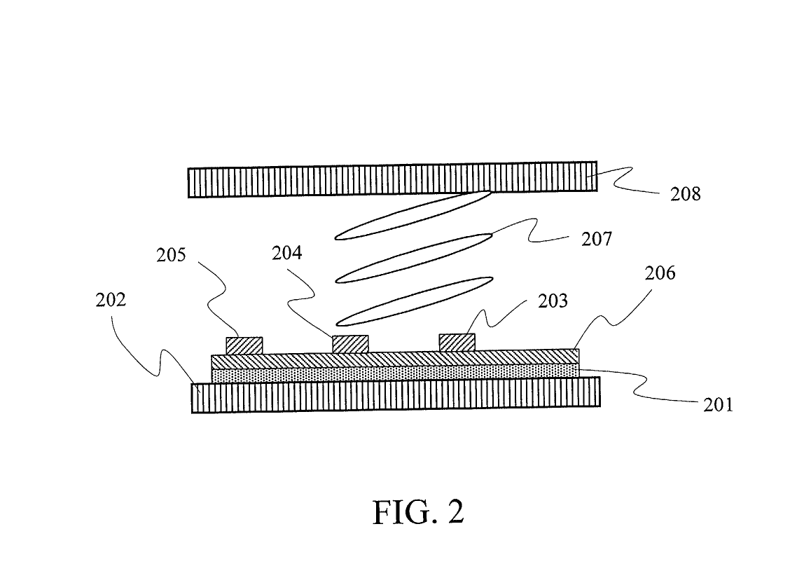

### DETAILED DESCRIPTION OF THE PREFERRED EMBODIMENTS

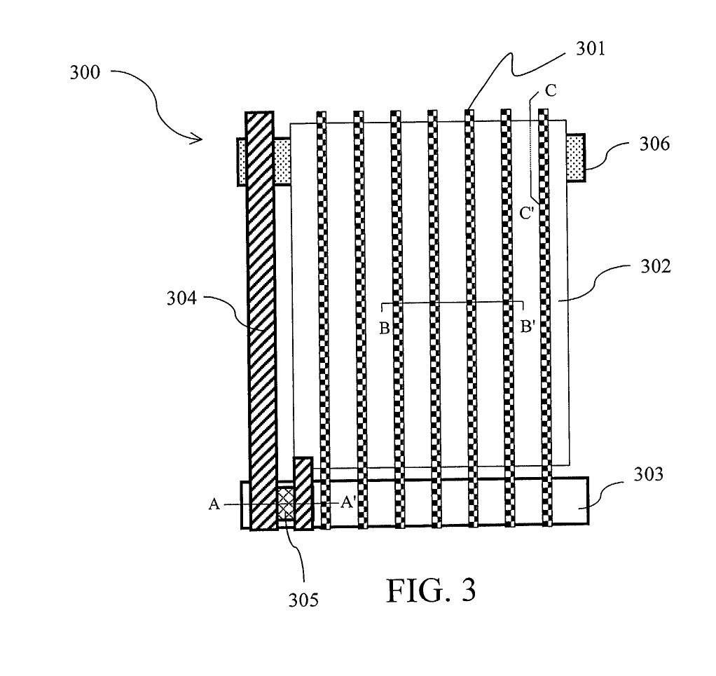

FIG. 3 is a top view showing the electrode structure 300 of a single pixel of a wide viewing angle liquid crystal display according to the first embodiment of the present invention. Referring to FIG. 3, the upper common electrode layer 301 of the electrode structure 300 is a stripe-shaped structure while the lower pixel electrode layer 302 is a plate-shaped structure. The scan signal line region 303 is perpendicular to the data signal line region 304 to form a pixel.

As shown in FIG. 3, there is a thin film transistor 305, used as a switching device, located near the crossing point of the scan signal line region 303 and the data signal line region 304 in a single pixel. On the other side, the auxiliary common line region 306 is perpendicular to the data signal line region 304. According to the invention, in every single pixel, the gate terminal of the thin film transistor used as the switching device connects to the scan signal lines, the drain terminal connects to the data signal line and the source terminal connects to the pixel electrode.

In the preferred embodiment, the plate-shaped pixel electrode 302 does not overlap the data signal line region 304 and the scan signal line region 303 while the stripe-shaped common electrode layer 301 extends above the scan signal line region 303. On the other side, the plate-shaped pixel electrode 302 crosses over the auxiliary common line region 306 while the stripe-shaped common electrode layer 301 extends over and above the plate-shaped pixel electrode 302. In the invention, the structure of the upper stripe-shaped and extended common electrode layer increases the effective transmission of light and has no effects of strong electric field at the comer. Residual electric charges are eliminated.

The following illustrates the detailed steps of the fabrication process of the electrode structure shown in FIG. 3 in the first embodiment. According to the invention, the fabrication process includes the formation of the substrate and various signal lines and pixel electrodes, the coverage of a passivation layer, and the formation of the common electrode layer. The steps of forming the substrate are shown by the cross section along line AA′ of FIG. 3. The steps of forming the common electrode layer are shown by the cross section along line BB′ of FIG. 3. The steps of the formation of the auxiliary common line region are shown by the cross section along line CC′ of FIG. 3.

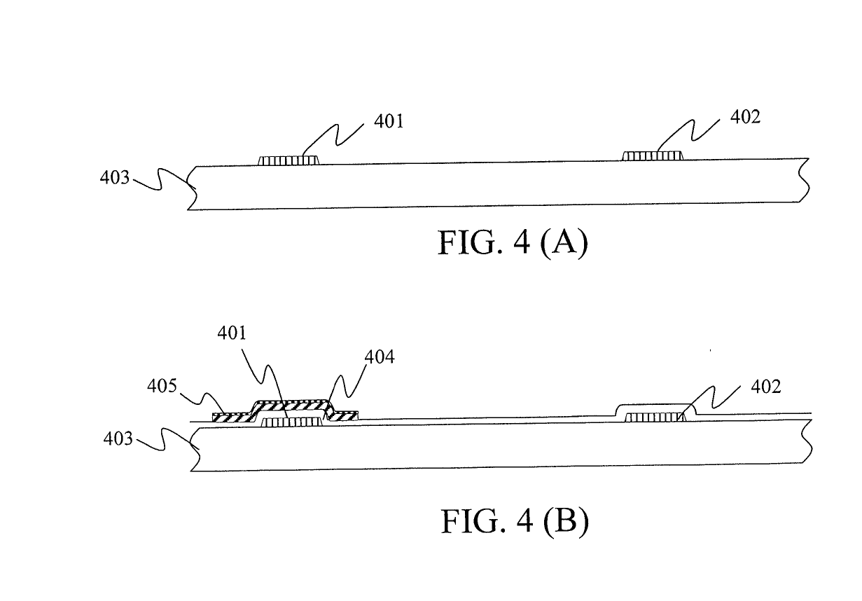

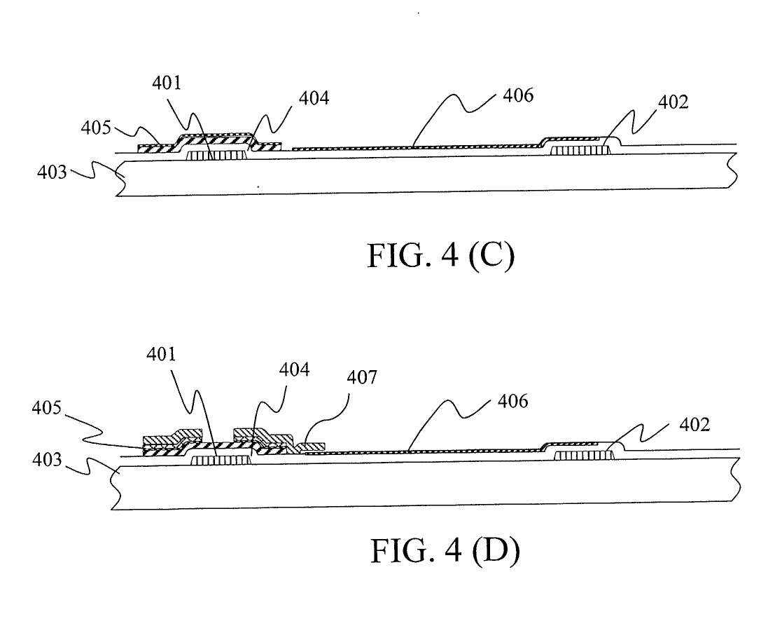

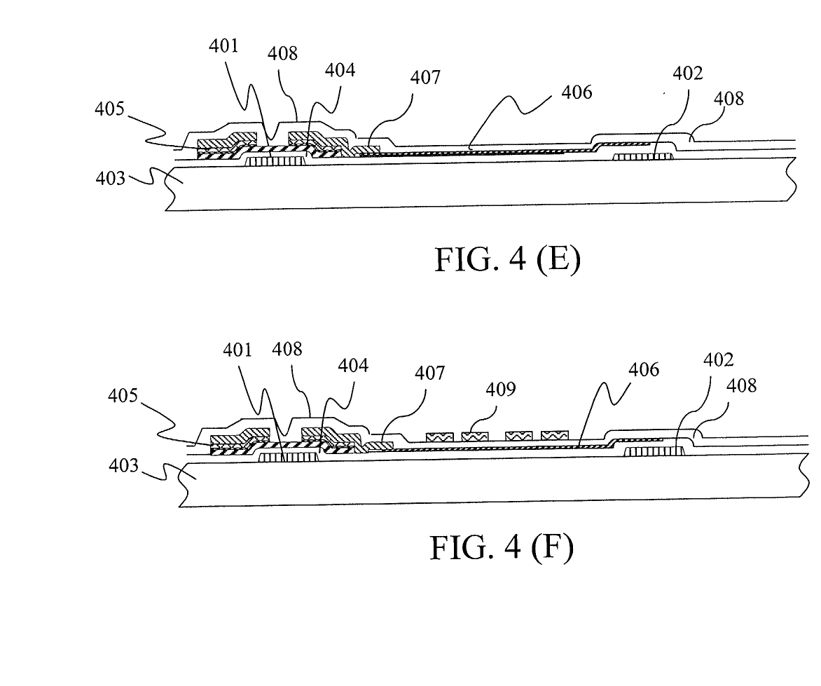

FIGS. 4(a) to 4(f) show the detailed process steps for fabricating the electrode structure in the first embodiment of the present invention. The formation of the substrate is similar to forming the substrate of a conventional TN mode liquid crystal display which comprises thin film transistors. In the embodiment, the present invention first forms the scan signal line metal layer 401 and the auxiliary common line metal layer 402 on a glass substrate 403. Metal layers 401 and 402 are usually formed on the same layer and use the same kind of material, as shown in FIG. 4(a).

After the step shown in FIG. 4(a), by covering an insulator 404 thereon, an island-like region 405 is formed to provide an active layer of the thin film transistor, as shown in FIG. 4(b). The thin film transistor comprises at least a gate terminal, a drain terminal and a source terminal. An indium-tin-oxide is then formed to provide the plate-shaped pixel electrode 406. The pixel electrode 406 does not cross over the island-like region 405, as shown in FIG. 4(c). Necessary multiple contact holes are formed outside the pixel matrix region to establish electrical contact for the metal layer 401 and 402 by using the same ITO layer.

After the step shown in FIG. 4(c), the data signal line metal layer 407 is formed above the island-like region 405, as shown in FIG. 4(d). The gate terminal of the thin film transistor connects to the scan signal line 401, the drain terminal connects to the data signal line metal layer 407 and the source terminal connects to the pixel electrode 406. The substrate is then covered by a passivation layer 408, as shown in FIG. 4(e). Necessary multiple contact holes are formed outside the pixel matrix region to establish electrical contact for the data signal line metal layer 407 by using the same ITO layer.

Finally, an indium-tin-oxide layer is formed above the pixel electrode 406 and the passivation layer 408 to fabricate the stripe-shaped common electrode layer 409, as shown in FIG. 4(f). The common electrode layer 409 is stripe-shaped, extended to both sides and parallel to the data signal line metal layer (not shown in FIG. 4(f)).

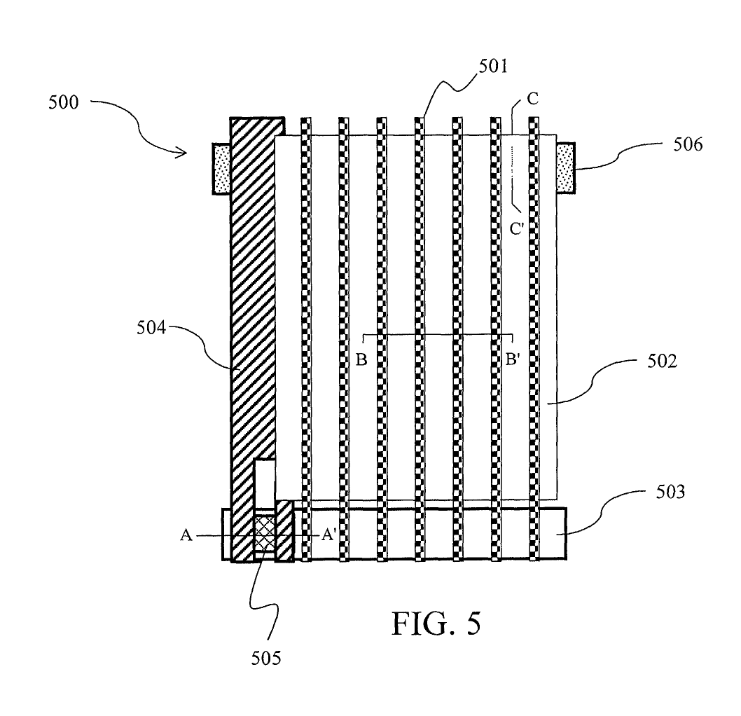

FIG. 5 is a top view showing the electrode structure of a single pixel of a wide viewing angle liquid crystal display according to the second embodiment of the present invention. Referring to FIG. 5, in this second preferred embodiment, the plate-shaped pixel electrode 502 overlaps the data signal line region 504 while the stripe-shaped common electrode layer 501 extends above the scan signal line region 503. On the other side, the plate-shaped pixel electrode 502 crosses over the auxiliary common line region 506 while the stripe-shaped common electrode layer 501 runs over and across the plate-shaped pixel electrode 502. Other structures are the same as those in the first preferred embodiment.

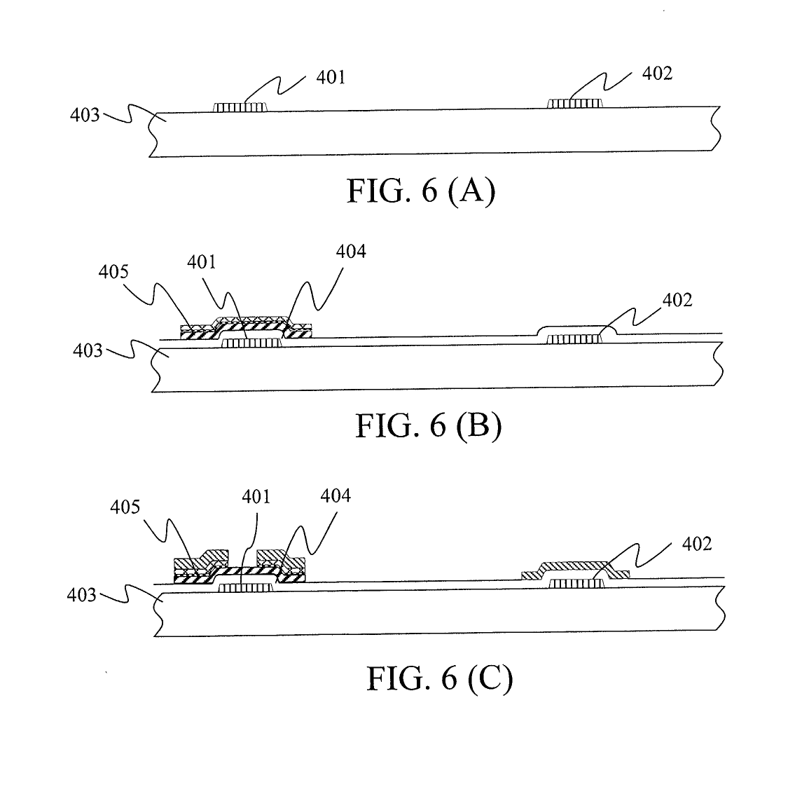

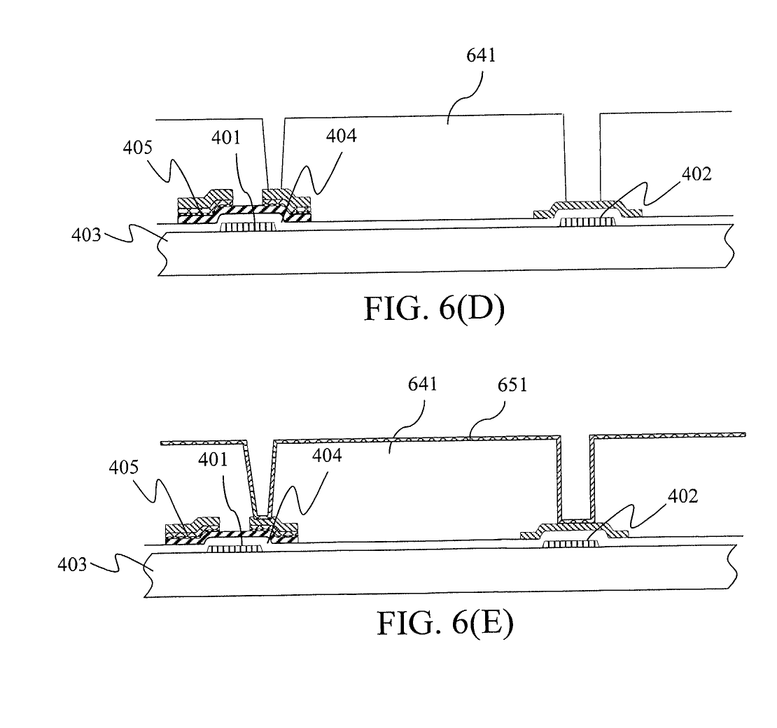

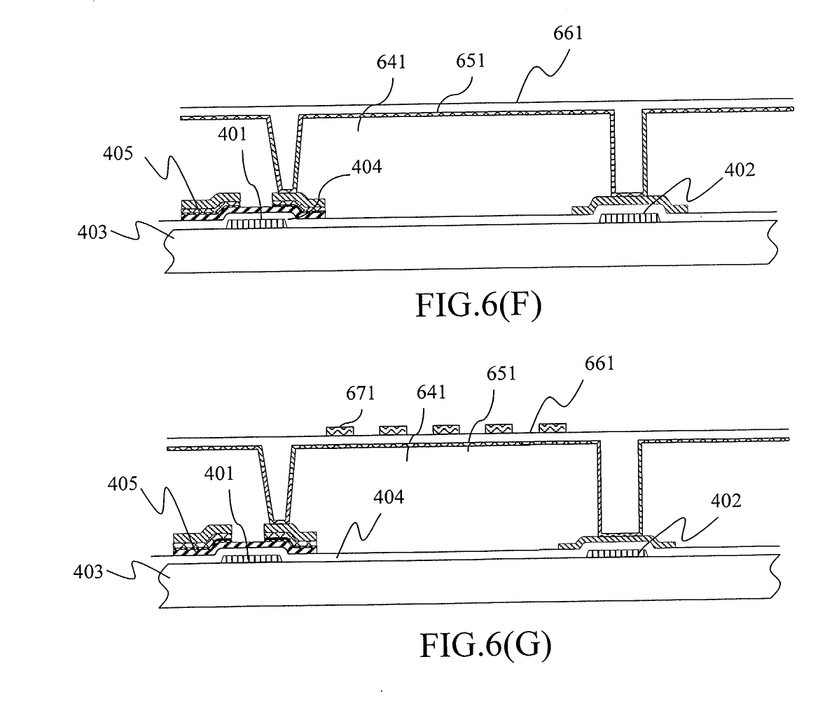

FIGS. 6(a) to 6(g) illustrate the process steps for fabricating the electrode structure in the second embodiment of the present invention. Similarly, the fabrication process in the second embodiment is illustrated by the cross section along line AA′, line BB′, and line CC′ of FIG. 5.

The fabrication processes shown in FIGS. 6(a) and 6(b) are the same as those in FIGS. 4(a) and 4(b) respectively. After the step shown in FIG. 6(b), a data signal line metal layer 407 is formed on the island-like region 405, as shown in FIG. 6(c). The substrate is covered by a passivation layer 641 and the top surface of the passivation layer is made flat, as shown in FIG. 6(d). An indium-tin-oxide layer is formed above the passivation layer to provide the plate-shaped pixel electrode 651. The pixel electrode 651 crosses over the island-like region 405, as shown in FIG. 6(e).

After the step shown in FIG. 6(e), an insulator 661 is formed above the device, as shown in FIG. 6(f). Electric contact can be established by forming multiple contact holes outside the pixel matrix region. Finally, an indium-tin-oxide layer is formed above the pixel electrode 651 and the passivation layer 661 to provide the stripe-shaped common electrode layer 671, as shown in FIG. 6(g).

In the second preferred embodiment, the upper common ITO pixel electrode layer is fabricated near the top of the electrode structure. The pixel electrodes and the common electrodes may overlap the data signal lines. More effective transmission of light are provided in the second preferred embodiment than those in the first preferred embodiment.

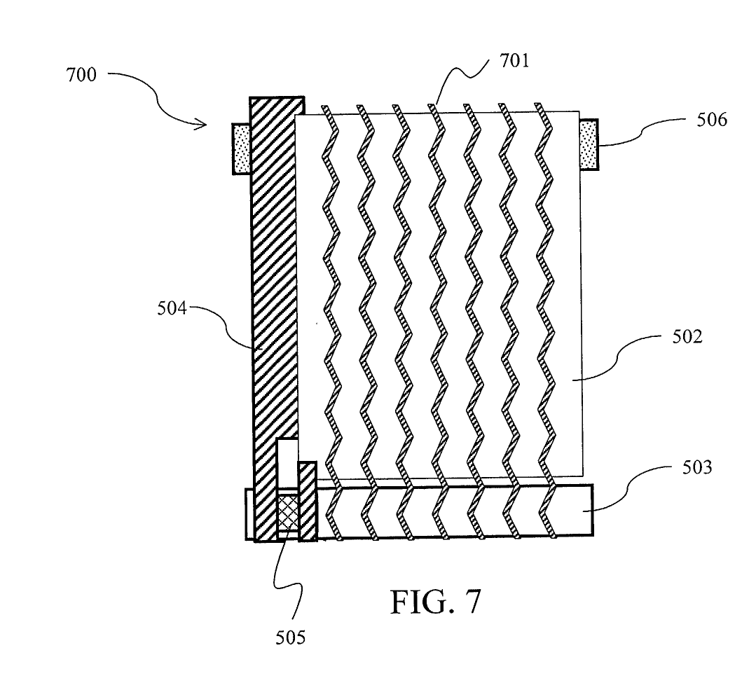

According to the third embodiment of the invention, the upper common electrode layer can also be designed with a herringbone-shaped structure as shown in FIG. 7. Similar to the second embodiment, the upper common ITO electrode layer in this third preferred embodiment is constructed near the top of the electrode structure. It should be obvious to a person skilled in the art that the herringbone-shaped structure can also be used for the upper common electrode layer in the first embodiment.

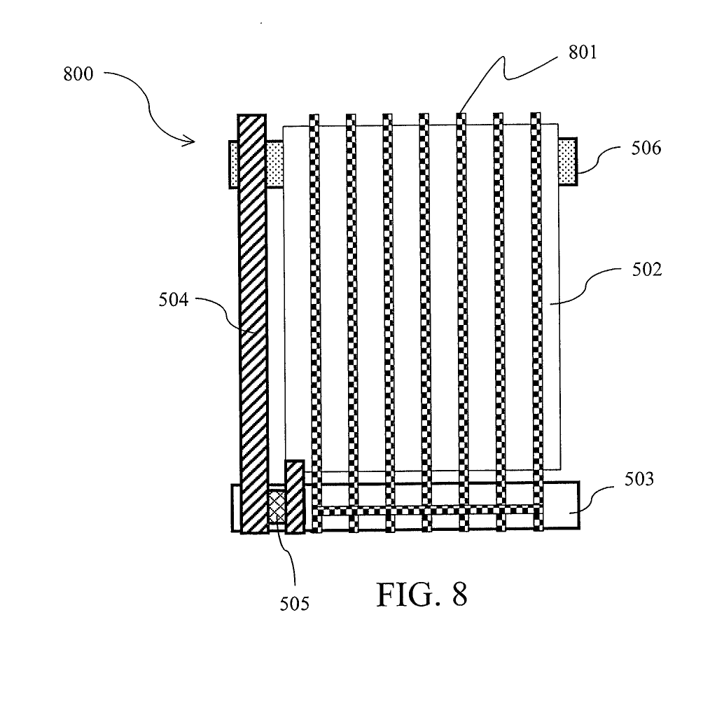

In addition, in order to reduce the resistance, the present invention also establishes the horizontal connection between the upper common electrodes at some proper locations, such as on the scan signal line region or the data signal line region. In the electrode structure shown in FIG. 8 of the fourth preferred embodiment, the upper common electrodes 801 located above the scan signal line region 503 are horizontally connected to each other.

In the electrode structure of the present invention, the common electrodes and pixel electrodes are made of conductive material. The conductive material may include transparent material or non-transparent material. Transparent conductive material can be indium-tin-oxide, SnO₂, N type amorphous silicon film, N type poly-silicon film, P type poly-silicon film, and ZnO. Non-transparent conductive material can be metallic material.

Although this invention has been described with a certain degree of particularity, it is to be understood that the present disclosure has been made by way of preferred embodiments only and that numerous changes in the detailed construction and combination as well as arrangement of parts may be restored to without departing from the spirit and scope of the invention as hereinafter set forth.

What is claimed is:

1. An electrode structure of a wide viewing angle liquid crystal display comprising:
a scan signal line;
a data signal line substantially perpendicular to said scan signal line, said scan signal line and said data signal line defining a pixel area;
a pixel electrode in said pixel area; and
a plurality of common electrodes running substantially in parallel with said data signal line and extending above said scan signal line, said common electrodes being above said pixel electrode.

2. The electrode structure of a wide viewing angle liquid crystal display as claimed in claim 1, each of said common electrodes further being connected together by connectors running above said scan signal line.

3. The electrode structure of a wide viewing angle liquid crystal display as claimed in claim 1, each of said common electrodes being stripe shaped.

4. The electrode structure of a wide viewing angle liquid crystal display as claimed in claim 1, each of said common electrodes being herringbone shaped.

5. The electrode structure of a wide viewing angle liquid crystal display as claimed in claim 1, wherein said pixel electrode overlaps said data signal line.

6. The electrode structure of a wide viewing angle liquid crystal display as claimed in claim 1, wherein said common electrodes are made of indium-tin-oxide, SnO₂, N-type amorphous silicon film, N type poly-silicon film, P type poly-silicon film, or ZnO.

7. The electrode structure of a wide viewing angle liquid crystal display as claimed in claim 1, said pixel electrode being plate shaped.

8. The electrode structure of a wide viewing angle liquid crystal display as claimed in claim 1, wherein said pixel electrode is made of indium-tin-oxide, SnO₂, N-type amorphous silicon film, N type poly-silicon film, P type poly-silicon film, or ZnO.

9. The electrode structure of a wide viewing angle liquid crystal display as claimed in claim 1, wherein contact holes are formed outside said pixel area for contacting said scan signal line and said data signal line.

10. A method of fabricating an electrode structure for a wide viewing angle liquid crystal display comprising the steps of
(a) preparing a glass substrate;
(b) forming a scan signal line on said substrate;
(c) covering said substrate and said scan line with an insulation layer;
(d) forming a pixel electrode above said insulation layer;
(e) forming an island region for an active switching device above said insulation layer;
(f) forming a data signal line above said island region, said data signal line being perpendicular to said scan signal line;
(g) covering said data signal line, said island region, and said pixel electrode with a passivation layer; and
(h) forming a plurality of common electrodes running in parallel with said data signal line and extending above said scan signal line, said common electrodes being above said pixel electrode.

11. The method of fabricating an electrode structure for a wide viewing angle liquid crystal display as claimed in claim 10, each of said common electrodes further being connected together by connectors running above said scan signal line.

12. The method of fabricating an electrode structure for a wide viewing angle liquid crystal display as claimed in claim 10, each of said common electrodes being stripe shaped.

13. The method of fabricating an electrode structure for a wide viewing angle liquid crystal display as claimed in claim 10, each of said common electrodes being herringbone shaped.

14. The method of fabricating an electrode structure for a wide viewing angle liquid crystal display as claimed in claim 10, wherein said common electrodes are made of indium-tin-oxide, SnO₂, N-type amorphous silicon film, N type poly-silicon film, P type poly-silicon film, or ZnO.

15. The method of fabricating an electrode structure for a wide viewing angle liquid crystal display as claimed in claim 10, said pixel electrode being plate shaped.

16. The method of fabricating an electrode structure for a wide viewing angle liquid crystal display as claimed in claim 10, wherein said pixel electrode is made of indium-tin-oxide, SnO₂, N-type amorphous silicon film, N type poly-silicon film, P type poly-silicon film, or ZnO.

17. A method of fabricating an electrode structure for a wide viewing angle liquid crystal display comprising the steps of:
(a) preparing a glass substrate;
(b) forming a scan signal line on said substrate;
(c) covering said substrate and said scan line with a first insulation layer;
(d) forming an island region for an active switching device above said first insulation layer;
(e) forming a data signal line above said island region, said data signal line being perpendicular to said scan signal line;
(f) covering said data signal line and said island region with a passivation layer;
(g) forming a pixel electrode above said passivation layer;
(h) covering said data signal line, said island region, and said pixel electrode with a second insulation layer; and
(i) forming a plurality of common electrodes running in parallel with said data signal line and extending above said scan signal line, said common electrodes being above said pixel electrode.

18. The method of fabricating an electrode structure for a wide viewing angle liquid crystal display as claimed in claim 17, each of said common electrodes further being connected together by connectors running above said scan signal line.

19. The method of fabricating an electrode structure for a wide viewing angle liquid crystal display as claimed in claim 17, each of said common electrodes being stripe shaped.

20. The method of fabricating an electrode structure for a wide viewing angle liquid crystal display as claimed in claim 10, each of said common electrodes being herringbone shaped.

21. The method of fabricating an electrode structure for a wide viewing angle liquid crystal display as claimed in claim 17, wherein said common electrodes are made of indium-tin-oxide, SnO₂, N-type amorphous silicon film, N type poly-silicon film, P type poly-silicon film, or ZnO.

22. The method of fabricating an electrode structure for a wide viewing angle liquid crystal display as claimed in claim 17, said pixel electrode overlapping said data signal line.

23. The method of fabricating an electrode structure for a wide viewing angle liquid crystal display as claimed in claim 17, said pixel electrode being plate shaped.

24. The method of fabricating an electrode structure for a wide viewing angle liquid crystal display as claimed in claim 17, wherein said pixel electrode is made of indium-tin-oxide, SnO₂, N-type amorphous silicon film, N type poly-silicon film, P type poly-silicon film, or ZnO.
